(19) United States
(12) Patent Application Publication
(10) Pub. No.: US 2025/0389685 A1
(43) Pub. Date: Dec. 25, 2025

(54) ELECTRICAL CONDUCTIVITY DETECTOR

(71) Applicant: SHIMADZU CORPORATION, Kyoto (JP)

(72) Inventor: Shintaro YAMAMOTO, Kyoto (JP)

(73) Assignee: SHIMADZU CORPORATION, Kyoto (JP)

(21) Appl. No.: 19/231,641

(22) Filed: Jun. 9, 2025

(30) Foreign Application Priority Data
Jun. 25, 2024 (JP) 2024-101852

(51) Int. Cl. G01N 27/08

(52) U.S. Cl. CPC G01N 27/08

(57) ABSTRACT

An electrical conductivity detector includes a sample cell (2) including a channel (10) through which a sample liquid flows and a pair of electrodes (12-12) disposed sandwiching the channel (10), a voltage application part (4) configured to apply a measurement voltage, which is alternating-current, between the pair of electrodes (12-12) of the sample cell (2), a measurement part (6) that outputs a measurement signal having a magnitude corresponding to an electrical conductivity of the sample liquid flowing in the channel (10) of the sample cell (2) based on a magnitude of a current flowing between the pair of electrodes (12-12), and a controller (8) controlling the voltage application part (4), the controller (8) being configured to reduce an error included in the measurement signal output from the measurement part (6) by changing a frequency of the measurement voltage applied between the pair of electrodes (12-12) by the voltage application part (4) for a measurement of the electrical conductivity of the sample liquid flowing through the channel (10) of the sample cell (2) during the measurement of the electrical conductivity, according to a magnitude of the measurement signal.

### BACKGROUND OF THE INVENTION

### 1. Field of the Invention

The present invention relates to an electrical conductivity detector used as a detector of an ion chromatograph.

### 2. Description of the Related Art

An ion chromatograph typically quantifies an ion component to be analyzed by separating an ion component in a sample with a separation column, then causing a sample liquid eluted from the separation column to pass through a suppressor to remove unnecessary ions other than the ion component to be analyzed, and measuring the electrical conductivity of the sample liquid having passed through the suppressor.

An electrical conductivity detector that measures the electrical conductivity of a sample liquid includes a sample cell provided with a pair of electrodes sandwiching a channel through which the sample liquid flows, with which the electrical conductivity of the sample liquid flowing through the channel in the sample cell is measured by applying a measurement voltage between the pair of electrodes and measuring a current flowing between the electrodes.

As the measurement voltage to be applied between the pair of electrodes, an alternating current voltage having a constant amplitude and frequency (for example, a sine wave) is used. When an alternating-current measurement voltage is applied between the pair of electrodes, a current corresponding to the electrical conductivity of the sample liquid flowing through the channel between the electrodes flows between the electrodes. The current flowing between the pair of electrodes is input to an amplifier, and a voltage signal (referred to as a detection signal) corresponding to the current flowing between the pair of electrodes is read at a constant cycle with an A/D converter. The detection signal read with the A/D converter is multiplied by a reference signal having the same frequency and phase as that of the measurement voltage in a multiplier. The output signal from the multiplier is caused to pass through a low-pass filter to remove a frequency component, and a measurement signal (direct current voltage) corresponding to the electrical conductivity of the sample liquid is obtained (see WO 2017/208561 A).

### SUMMARY OF THE INVENTION

The magnitude of the current flowing between the electrodes of the sample cell is affected not only by a solution resistance Rsol (reciprocal of the electrical conductivity) of the sample liquid flowing through the channel between the electrodes, but also by a charge transfer resistance Rct and an electric double layer capacitance Cdl. The charge transfer resistance Rct represents the difficulty of occurrence of a charge transfer reaction, and it decreases when the charge transfer reaction is likely to occur and increases when the charge transfer reaction is unlikely to occur. To correctly measure the electrical conductivity of the sample liquid, it is desirable that the influence of the charge transfer resistance Rct and the electric double layer capacitance Cdl is small. However, since the charge transfer resistance Rct increases as the electrical conductivity of the sample liquid increases, the error due to the charge transfer resistance Rct included in the measurement signal increases as the electrical conductivity of the sample liquid increases.

The present invention has been made in view of the above problem, and an object of the present invention is to reduce an error of a measurement signal due to an influence of charge transfer resistance when the electrical conductivity of a sample liquid is high.

FIG. 3 illustrates an equivalent circuit of a sample cell including the solution resistance Rsol, the charge transfer resistance Rct, and the electric double layer capacitance Cdl. The charge transfer resistance Rct and the electric double layer capacitance Cdl are in parallel relationship with each other, and the solution resistance Rsol is in series relationship with the parallel circuit of the charge transfer resistance Rct and the electric double layer capacitance Cdl. The impedance Z of the entire equivalent circuit can be expressed as:

$$Z = {Z}^{′} - {jZ}^{″} .$$

Z′ and Z″ can be respectively calculated by the following equations.

$${Z}^{′} = {R}_{sol} + \frac{{R}_{ct}}{1 + {( 2 π f )}^{2} {{R}^{2}}_{ct} {{C}^{2}}_{dl}}$$

$${Z}^{″} = \frac{( 2 π f ) {{R}^{2}}_{ct} {C}_{dl}}{1 + {( 2 π f )}^{2} {{R}^{2}}_{ct} {{C}^{2}}_{dl}}$$

“f” is the frequency of the measurement voltage applied between the pair of electrodes of the sample cell. From the above equations, the real part of the impedance Z of the entire equivalent circuit approaches the solution resistance Rsol as the frequency f is higher, and approaches the sum of the solution resistance Rsol and the charge transfer resistance Rct as the frequency f is lower. Thus, it can be said that the higher the frequency f, the higher the measurement accuracy of the electrical conductivity.

Meanwhile, as described above, the detection signal output from the amplifier is periodically sampled by the A/D converter, but when the frequency f of the voltage applied between the electrodes is high, the number of samples of the detection signal in one cycle decreases, the influence of the distortion of the sin wave or the angle of the phase of the detection signal integrated in one sampling increases, and the error included in the phase difference between the detection signal read by the A/D converter and the reference signal increases. The influence of the error increases as the electrical conductivity of the sample liquid decreases, and the accuracy and linearity of the measured value deteriorate particularly when the electrical conductivity of the sample liquid is low. Thus, it is not sufficient to simply increase the frequency of the measurement voltage to be applied between the electrodes of the sample cell.

Thus, in the present invention, the above problem is solved by changing the frequency of the voltage to be applied between the electrodes of the sample cell according to the electrical conductivity of a sample water flowing through the channel of the sample cell. That is, an electrical conductivity detector according to the present invention includes a sample cell including a channel through which a sample liquid flows and a pair of electrodes disposed sandwiching the channel, a voltage application part configured to apply a measurement voltage, which is alternating-current, between the pair of electrodes of the sample cell, a measurement part that outputs a measurement signal having a magnitude corresponding to an electrical conductivity of the sample liquid flowing in the channel of the sample cell based on a magnitude of a current flowing between the pair of electrodes, and a controller configured to control the voltage application part, the controller being configured to reduce an error included in the measurement signal output from the measurement part by changing a frequency of the measurement voltage applied between the pair of electrodes by the voltage application part for a measurement of the electrical conductivity of the sample liquid flowing through the channel of the sample cell during the measurement of the electrical conductivity, according to a magnitude of the measurement signal.

According to the electrical conductivity detector of the present invention, the frequency of the measurement voltage to be applied between the pair of electrodes for the measurement of the electrical conductivity of the sample liquid flowing through the channel of the sample cell is changed during the measurement of the electrical conductivity according to the magnitude of the measurement signal output from the measurement signal, whereby the error included in the measurement signal is reduced. Thus, the error of the measurement signal due to the influence of the charge transfer resistance when the electrical conductivity of the sample liquid is high can be reduced.

### BRIEF DESCRIPTION OF THE DRAWINGS

FIG. 1 is a schematic configuration diagram illustrating an embodiment of an electrical conductivity detector;

FIG. 2 is a flowchart illustrating an example of the control of a measurement voltage of the embodiment; and

FIG. 3 is a diagram for describing an equivalent circuit of a sample cell of the electrical conductivity detector.

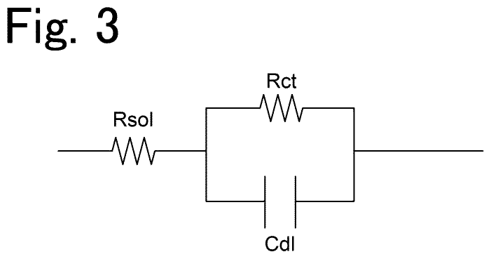

### DETAILED DESCRIPTION OF THE INVENTION

Hereinafter, an embodiment of an electrical conductivity detector according to the present invention will be described with reference to the drawings.

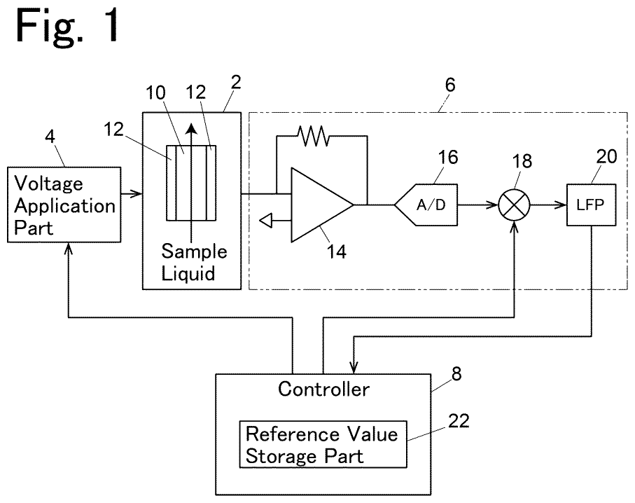

As illustrated in FIG. 1, the electrical conductivity detector of this embodiment includes a sample cell 2, a voltage application part 4, a measurement part 6, and a controller 8.

The sample cell 2 includes a channel 10 through which a sample liquid flows, and a pair of electrodes 12-12 disposed to face each other sandwiching the channel 10. The voltage application part 4 is configured to apply an alternating-current measurement voltage Vosin(ωt) between the pair of electrodes 12-12 of the sample cell 2.

The measurement part 6 is a one-phase lock-in amplifier, including an amplifier 14, an A/D converter 16, a multiplier 18, and a low-pass filter (hereinafter, LPF) 20. The amplifier 14 outputs a detection signal A sin(ωt+φ) having an amplitude A corresponding to the magnitude of the current flowing between the pair of electrodes 12-12 of the sample cell 2. The A/D converter 16 reads the detection signal A sin(ωt+φ) from the amplifier 14 at a constant time period and outputs the detection signal to the multiplier 18 and the LFP 20. After the detection signal A sin(ωt+φ) output from the A/D converter 16 is multiplied by a reference signal sin (ωt) having the same frequency (ωt) as the detection signal A sin(ωt+p) in the multiplier 18, the frequency component is removed by the low-pass filter 20, and finally, a measurement signal (λ/2)cos φ including the amplitude A and the phase difference φ having a magnitude corresponding to the value of the current flowing between the pair of electrodes 12-12 is obtained. The phase difference φ between the detection signal A sin(ωt+φ) and the reference signal sin (ωt) is adjusted in advance.

The controller 8 is realized by an electronic circuit including a central processing part (CPU) and an information storage memory, and controls the measurement voltage to be applied between the pair of electrodes 12-12 of the sample cell 2 by the voltage application part 4 and the reference signal to be multiplied by the detection signal in the multiplier 18. The controller 8 monitors the magnitude of the measurement signal obtained by the measurement part 6 during the measurement of the electrical conductivity of the sample water, and is configured to set the measurement voltage and the frequency f of the reference signal to correspond to the magnitude of the measurement signal. The controller 8 includes a reference value storage part 22 that stores a reference value of the measurement signal obtained by the measurement part 6, and changes the measurement voltage and the frequency of the reference signal depending on whether the measurement signal exceeds the reference value stored in the reference value storage part 22. The reference value storage part 22 is realized by a partial storage area of the information storage memory. As the reference value, for example, it is conceivable to set 1+α (mS/cm) when switching from low electrical conductivity to high electrical conductivity, to set 1−α (mS/cm) when switching from high electrical conductivity to low electrical conductivity, and to set α to 10 to 100 (μS/cm). The present invention is not limited to these values.

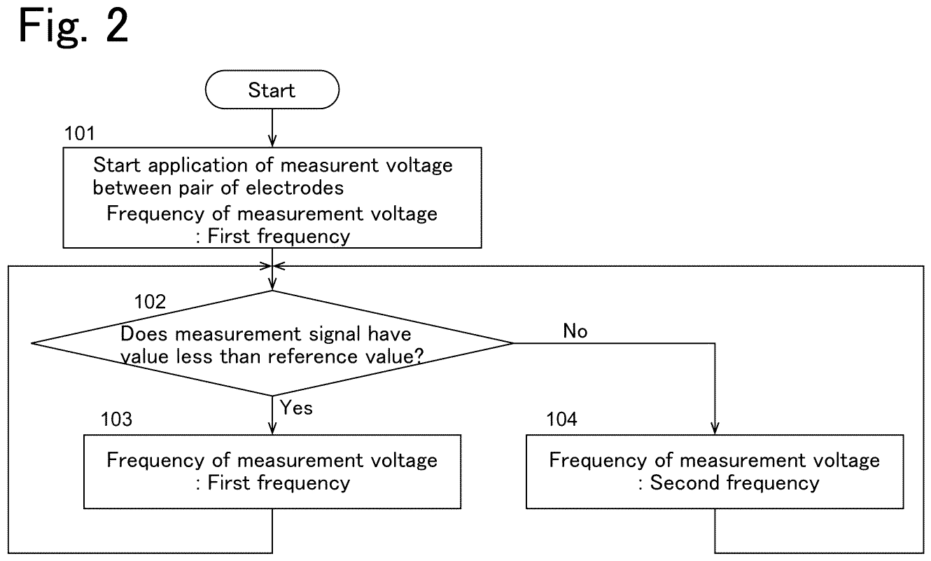

The control of the frequency of the measurement voltage will be described with reference to FIG. 1 and the flowchart of FIG. 2.

When the measurement of the electrical conductivity is started, the controller 8 controls the voltage application part 4 to apply an alternating-current measurement voltage having a predetermined amplitude and a first frequency (for example, 1 kHz) between the pair of electrodes 12-12 of the sample cell 2 (step 101). The controller 8 constantly determines whether the measurement signal obtained by the measurement part 6 has a value less than the reference value during the measurement of the electrical conductivity (step 102). When the measurement signal has a value less than the reference value (step 102: Yes), the controller 8 sets the frequency of the measurement voltage to the first frequency (step 103), and when the measurement signal exceeds the reference value (step 102: No), the controller 8 sets the frequency of the measurement voltage to a second frequency (for example, 12.5 kHz) higher than the first frequency (step 104). The controller 8 similarly changes the frequency of the reference signal to be multiplied by the detection signal in the multiplier 18 along with the change of the frequency of the measurement voltage. The measurement part 6 reads the detection signal at a constant time period, and when the frequency of the measurement voltage increases, the number of samples per cycle of the detection signal decreases. Thus, the lower the frequency of the measurement voltage, the more accurate the phase adjustment can be performed. Thus, the frequency of the measurement voltage is decreased when the electrical conductivity is low at which the charge transfer resistance Rct becomes dominant, and the frequency is increased only when the electrical conductivity is high at which the solution resistance Rsol and the electric double layer capacitance Cdl become dominant.

In the above embodiment, one value is set in advance as the reference value, and the frequency of the measurement voltage and the frequency of the reference signal are changed depending on whether the measurement signal exceeds the reference value. However, the present invention is not limited to this configuration, and a plurality of reference values may be set, and the frequencies of the measurement voltage and the reference signal may be changed in multiple stages according to the magnitude of the measurement voltage.

The embodiment described above is merely an example of the embodiments of the electrical conductivity detector according to the present invention. The embodiments of the electrical conductivity detector according to the present invention are as follows.

In an embodiment of the electrical conductivity detector according to the present invention,
the electrical conductivity detector includes
a sample cell including a channel through which a sample liquid flows and a pair of electrodes disposed sandwiching the channel,
a voltage application part configured to apply a measurement voltage, which is alternating-current, between the pair of electrodes of the sample cell,
a measurement part that outputs a measurement signal having a magnitude corresponding to an electrical conductivity of the sample liquid flowing in the channel of the sample cell based on a magnitude of a current flowing between the pair of electrodes, and
a controller configured to control the voltage application part, the controller being configured to reduce an error included in the measurement signal output from the measurement part by changing a frequency of the measurement voltage applied between the pair of electrodes by the voltage application part for a measurement of the electrical conductivity of the sample liquid flowing through the channel of the sample cell during the measurement of the electrical conductivity, according to a magnitude of the measurement signal.

In a specific aspect of the embodiment described above, the electrical conductivity detector further includes a reference value storage part that stores a reference value of the measurement signal, wherein the controller is configured to set the frequency of the measurement voltage to a first frequency when the measurement signal has a value less than the reference value.

In the specific aspect described above, the controller may be configured to set the frequency of the measurement voltage to a second frequency larger than the first frequency when the measurement signal has a value equal to or more than the reference value.

### DESCRIPTION OF REFERENCE SIGNS

2 sample cell
4 voltage application part
6 measurement part
8 controller
10 channel
12 electrode
14 amplifier
16 A/D converter
18 multiplier
20 low-pass filter
22 reference value storage part

What is claimed is:

1. An electrical conductivity detector comprising:
a sample cell including a channel through which a sample liquid flows and a pair of electrodes disposed sandwiching the channel;
a voltage application part configured to apply a measurement voltage, which is alternating-current, between the pair of electrodes of the sample cell;
a measurement part that outputs a measurement signal having a magnitude corresponding to an electrical conductivity of the sample liquid flowing in the channel of the sample cell, based on a magnitude of a current flowing between the pair of electrodes; and
a controller configured to control the voltage application part, the controller being configured to reduce an error included in the measurement signal output from the measurement part by changing a frequency of the measurement voltage applied between the pair of electrodes by the voltage application part for a measurement of the electrical conductivity of the sample liquid flowing through the channel of the sample cell during the measurement of the electrical conductivity, according to a magnitude of the measurement signal.

2. The electrical conductivity detector according to claim 1, further comprising a reference value storage part that stores a reference value of the measurement signal,
wherein the controller is configured to set the frequency of the measurement voltage to a first frequency when the measurement signal has a value less than the reference value.

3. The electrical conductivity detector according to claim 2, wherein the controller is configured to set the frequency of the measurement voltage to a second frequency larger than the first frequency when the measurement signal has a value equal to or more than the reference value.
